(19) United States
(12) Patent Application Publication
(10) Pub. No.: US 2016/0328030 A1
(43) Pub. Date: Nov. 10, 2016

(54) INFORMATION PROCESSING APPARATUS

(71) Applicant: FUJITSU LIMITED, Kawasaki-shi (JP)

(72) Inventors: Masatoshi KIMURA, Kawasaki (JP); Akinobu KAWANO, Kawasaki (JP)

(73) Assignee: FUJITSU LIMITED, Kawasaki-shi (JP)

(21) Appl. No.: 15/212,214

(22) Filed: Jul. 16, 2016

Related U.S. Application Data
(63) Continuation of application No. PCT/JP2014/052328, filed on Jan. 31, 2014.

(51) Int. Cl. G06F 3/0346; G06T 3/60; G09G 5/00

(52) U.S. Cl. CPC G06F 3/0346; G09G 5/003; G06T 3/60; G09G 2300/04; G09G 2320/0626; G09G 2340/0492; G09G 2354/00

(57) ABSTRACT

An information processing apparatus includes a body, and a display detachably provided on the body. The display includes an attitude notifying device configured to generate and notify, to the body, attitude data of the display based on a change in attitude of the display detected in a state in which the display is detached from the body. The body includes a rotation processing device configured to perform a rotation process on image data displayed on the display and output rotated image data, based on the attitude data of the display, and a communication device configured to transmit the rotated image data to the display.

### CROSS-REFERENCE TO RELATED APPLICATIONS

This application is a continuation application of International Application No. PCT/JP2014/052328 filed on Jan. 31, 2014 and designated the U.S., the entire contents of which are incorporated herein by reference.

### FIELD

The embodiments discussed herein are related to an information processing apparatus.

### BACKGROUND

An electronic apparatus, such as a tablet, a smartphone, or the like, includes an acceleration sensor or the like. A change in attitude of a body of the electronic apparatus can be detected, according to a sensor value output from the sensor. The electronic apparatus starts a rotation control application that operates on an OS (Operating System), and causes the OS to control rotation of an image on a screen according to the change in the attitude of the body of the electronic apparatus.

In the electronic apparatus, such as the tablet, the smartphone, or the like, the body and the display are integrally formed. In this case, the OS installed in the electronic apparatus monitors the sensor value, and controls the rotation of the image on the screen in real-time or at a stage when the body settles to a predetermined attitude. For example, in a case in which the body settles to an attitude rotated by 90° from an original attitude, the OS executes a process to rotate the image by 90°, and displays the 90°-rotated image on the display. Accordingly, head and tail of the image on the screen can be displayed correctly by following the change in the attitude of the display.

In a case in which the electronic apparatus is a PC (Personal Computer), the rotation of the image on the screen can be controlled by setting an image rotation function using a shortcut on a keyboard, or by selecting a rotation direction of the image from a setting on the display.

On the other hand, in the electronic apparatus in which the body and the display are separately provided and the OS is installed in the body, an example of a method of controlling the rotation of the image at the display provides a scaler in the display. The scaler detects the rotation of the display. Hence, after rotating the image according to the rotation of the display detected by the scaler, the rotated image may be notified to the OS.

However, according to the method of rotating the image at the display, the direction of scanning lines of the image changes due to the rotation of the image. For this reason, image data needs to be temporarily stored in a buffer memory in order to display the rotated image on the screen. As a result, when rotating the image at the display, the additional provision of the scaler and the buffer memory increases the circuit scale, thereby making it difficult to form the display that is thin and light in weight. In addition, the additional provision of the scaler and the buffer memory may cause heat to be generated inside the display, and cause an increased power drain from a battery. Consequently, the additional provision of the scaler and the buffer memory may make it difficult for the display to operate for a long period of time.

An example of related art includes Japanese National Publication of International Patent Application No. 2011-516974, for example.

### SUMMARY

Accordingly, it is an object in one aspect of the embodiments to provide an information processing apparatus including a body and a display detachably provided on the body, that can rotate an image on the display having no image rotating function, according to an attitude of the display.

According to one aspect of the embodiments, an information processing apparatus including a body, and a display detachably provided on the body, wherein the display includes a first processor configured to perform a process including generating attitude data of the display based on a change in attitude of the display detected in a state in which the display is detached from the body, to notify the attitude data to the body, and wherein the body includes a second processor configured to perform a process including performing a rotation process on image data displayed on the display and output rotated image data, based on the attitude data of the display, and transmitting the rotated image data to the display.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a hardware configuration of a PC in one embodiment;

FIG. 2 is a block diagram illustrating an example of a hardware configuration of a display in one embodiment;

FIG. 3 is a block diagram illustrating an example of a functional configuration of wireless devices in one embodiment;

FIG. 4 is a block diagram illustrating an example of a docking state of the wireless devices in one embodiment;

FIG. 5 is a flow chart for explaining an example of a screen rotation process in one embodiment;

FIG. 6 is a time chart for explaining the example of the screen rotation process in one embodiment;

FIGS. 7A, 7B, and 7C are diagrams for explaining effects of the screen rotation process in one embodiment; and

FIG. 8 is a flow chart for explaining the screen rotation process illustrated in FIGS. 7A through 7C.

### DESCRIPTION OF EMBODIMENTS

Preferred embodiments of the present invention will be described with reference to the accompanying drawings. In the specification and drawings, those parts that have substantially the same functional configuration are designated by the same reference numeral, and a description of the parts that are substantially the same will not be repeated.

A description will now be given of the information processing apparatus in each embodiment according to the present invention. In one embodiment, the information processing apparatus includes a body, and a display detachably provided on the body. In this embodiment, a description will be given of an example in which the body is a PC, and the display is a portable wireless display. However, a device that is detachably provided on the body is not limited to the display, and may be any device having a wireless communication function. For example, the device that is detachably provided on the body may be a game device having a display panel, a music player having a display panel, or the like.

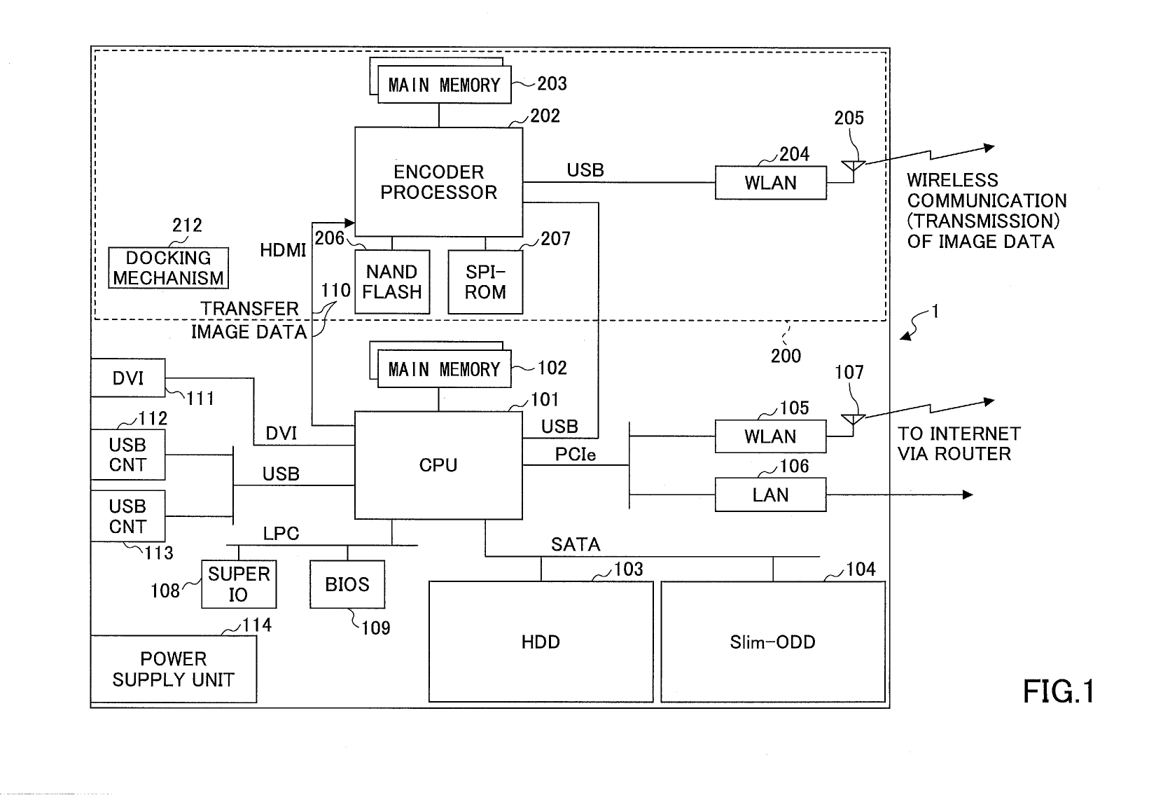

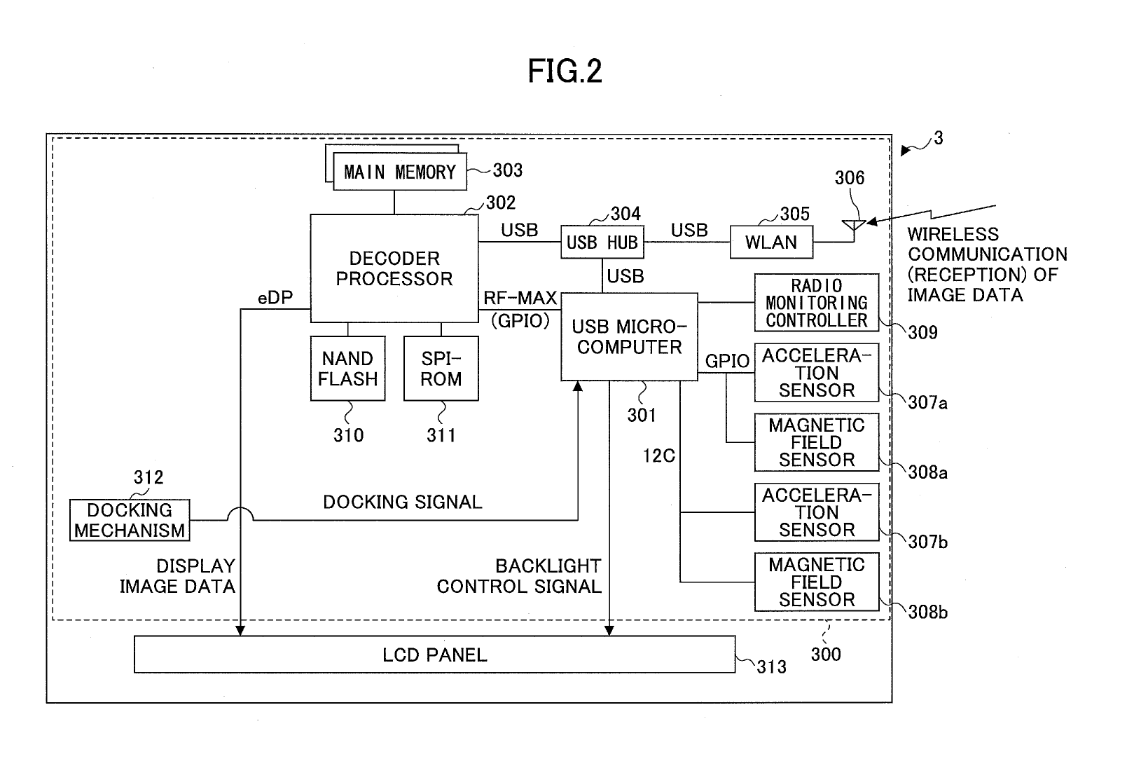

FIG. 1 is a block diagram illustrating an example of a hardware configuration of the PC in one embodiment, and FIG. 2 is a block diagram illustrating an example of a hardware configuration of the display in one embodiment. In the information processing apparatus in this embodiment, a display 3 illustrated in FIG. 2 is detachably provided on a PC 1 illustrated in FIG. 1, and may be used in a state detached from the PC 1. Image data to be displayed on the display 3 may be transferred from the PC 1 to the display 3. An image data transfer process is performed between a wireless device 200 of the PC 1, and a wireless device 300 of the display 3. The wireless device 200 may be an IC (Integrated Circuit) chip provided in the PC 1. The wireless device 300 may be an IC chip provided in the display 3. In this embodiment, the wireless devices 200 and 300 are formed by hardware, however, at least one of the wireless devices 200 and 300 may be formed by software.

In the information processing apparatus in this embodiment described hereunder, the wireless device 200 within the PC 1 may function as a transmitting end device that transmits the image data of the PC 1, and the wireless device 300 within the display 3 may function as a receiving end device that receives the image data transmitted from the wireless device 200. In other words, the PC 1 may operates as an AC (Access Point), and the display 3 may operate as an STA (Station). A docking mechanism is provided in each of the wireless devices 200 and 300, and the wireless devices 200 and 300 may be physically docked via the respective docking mechanisms.

First, a description will be given of the hardware configuration of the PC 1 including the wireless device 200, and the hardware configuration of the display 3 including the wireless device 300. Next, a description will be given of functional configurations of the wireless devices 200 and 300. Finally, a description will be given of a process (hereinafter also referred to as a “screen rotation process”) to rotate an image on a screen, according to a rotation of the display 3.

[Hardware Configuration of PC 1 Including Wireless Device 200]

First, a description will be given of the hardware configuration of the PC 1 including the wireless device 200 in one embodiment of the present invention, by referring to FIG. 1. FIG. 1 illustrates an example of the hardware configuration of the PC 1 including the wireless device 200 in one embodiment.

In this embodiment, the PC 1 includes a CPU (Central Processing Unit) 101, a main memory 102, an HDD (Hard Disk Drive) 103, and a slim-ODD (Optical Disk Drive) 104. The PC 1 also includes a WLAN (Wireless Local Area Network) 105, a LAN (Local Area Network) 106, an antenna 107, and a super IO (Input/Output) 108. The PC 1 further includes a BIOS (Basic Input Output System) memory 109, an HDMI (High Definition Multimedia Interface) 110, and a DVI (Digital Visual Interface) 111. The PC 1 also includes an USBCNT (Universal Serial Bus CoNTroller) 112, an USBCNT 113, and a power supply unit 114. The wireless device 200 is also provided within the PC 1.

The CPU 101 is an example of a main processing circuit of the PC 1. The main memory 102, the HDD 103, and the slim-ODD 104 are connected to the CPU 101 via buses. The WLAN 105, the LAN 106, the super IO 108, the BIOS memory 109, the HDMI 110, the DVI 111, the USBCNT 112, and the USBCNT 113 are connected to the CPU 101 via buses. The WLAN 105 is connected to the antenna 107. The power supply unit 114 supplies power to each part of the PC 11, including the CPU 101. The illustration of power lines for supplying the power to each part of the PC 11 is omitted in FIG. 1.

The HDD 103 is an example of a nonvolatile storage device that stores programs and data. The programs and the data stored in the HDD 103 include the OS that is basic software controlling the entire PC 1, application software providing various functions on the OS, various kinds of data, or the like. The HDD 103 may store the OS, installed application software (hereinafter also simply referred to as “applications”), uninstallers, registries, or the like. The HDD 103 may store a rotation control application (or program) for executing the screen rotation process which will be described later.

The slim-ODD 104 is an example of an optical disk drive. In a case in which distribution type applications, update data, or the like are distributed in the form of an optical disk, the slim-ODD 104 reads the applications, the data, or the like from the distributed optical disk and stores the read applications, data, or the like.

The WLAN 105 performs a wireless communication via the antenna 107. The WLAN 105 is connected to a network, such as the Internet or the like, via a router, and transmits data to and receives data from an outside (that is, an external device or the like). The LAN 106 is similarly connected to a network, such as the Internet or the like, and transmits data to and receives data from the outside. The distribution type applications, the update data, or the like may be downloaded via the WLAN 105 or the LAN 106, for example.

The super IO 108 is an example of an I/O (Input/Output) interface. For example, a keyboard, a mouse, or the like may be connected to the super IO 108. The BIOS memory 109 is an example of a nonvolatile storage device that stores a program group (for example, a BIOS) for controlling the disk drive, the keyboard, a video card, or the like connected to the PC 1.

The HDMI 110 is an example of an interface that transmits digital video and audio. In this embodiment, the image data or the like stored in the PC 1 via the HDMI 110 are transferred to the wireless device 200, and are transmitted to the display 3 by wireless transmission.

The DVI 111 may be connected to a monitor, for example. The DVI 111 is an example of an interface that outputs the image data or the like stored in the PC 1 to the monitor. The USBCNTs 112 and 113 are examples of control circuits that control USB devices connected to USB connectors of the PC 1.

[Wireless Device 200]

A description will be given of a hardware configuration of the wireless device 200 provided in the PC 1. The wireless device 200 includes an encoder processor 202, a main memory 203, a WLAN 204, a NAND flash memory 206, an SPI-ROM (Serial Peripheral Interface-Read Only Memory) 207, and a docking mechanism 212.

The main memory 203, the NAND flash memory 206, and the SPI-ROM 207 are connected to the encoder processor 202 via buses. The WLAN 204 is connected to the encoder processor 202 via an USB (Universal Serial Bus). In addition, the WLAN 204 is connected to an antenna 205, and transmits the image data stored in the PC 1 to the display 3.

The encoder processor 202 is an example of a main processing circuit of the wireless device 200. The encoder processor 202 may be formed by a dedicated processor for performing processes of functions more discrete than those of the CPU 101, and having a lower power consumption than the CPU 101. The image data stored in the PC 1 are transferred from the PC 1 to the wireless device 200 via the HDMI 110, and are input to the encoder processor 202. For example, the encoder processor 202 subjects the image data to a processing such as compression, encoding, or the like, and thereafter transmits the processed image data to the wireless device 300 (that is, the display 3) via the WLAN 204 and the antenna 205.

USB data transmitted from the display 3 by wireless communication may include attitude data indicating attitude of the display 3, such as an orientation (or direction), an inclination, a rotation direction or a rotation angle, or the like of the display 3, for example. The USB data are transferred from the encoder processor 202 to the CPU 101, and are used when the CPU 101 executes the screen rotation process which will be described later.

At least one of the NAND flash memory 206 and the SPI-ROM 207 may store programs for executing the screen rotation process.

The docking mechanism 212 may be a connector having a structure capable of connecting to a docking mechanism 312 provided on the wireless device 300 illustrated in FIG. 2. A plurality of terminals are provided on the docking mechanism 212, and enables electrical connection between the wireless devices 200 and 300 by physically docking to the docking mechanism 312. In this embodiment, a docking signal is set to a high level (or first logic level) when the wireless devices 200 and 300 are not docked to each other, and is set to a low level (or second logic level) when the wireless devices 200 and 300 are docked to each other via the respective docking mechanisms 212 and 312.

[Hardware Configuration of Display 3 Including Wireless Device 300]

Next, a description will be given of the hardware configuration of the display 3 including the wireless device 300 in one embodiment of the present invention, by referring to FIG. 2. The wireless device 300 includes an USB microcomputer 301, a decoder processor 302, a main memory 303, an USB hub 304, a WLAN 305, acceleration sensors 307a and 307b (hereinafter also generally referred to as “an acceleration sensor 307”), magnetic field sensors 308a and 308b (hereinafter also generally referred to as “a magnetic field sensor 308”), a radio monitoring controller 309, a NAND flash memory 310, an SPI-ROM 311, and the docking mechanism 312. The acceleration sensors 307a and 307b, and the magnetic field sensors 308a and 308b, are connected to the USB microcomputer 301 via different buses (or I/O IFs (Input/Output InterFaces).

In this embodiment, the acceleration sensor 307 and the magnetic field sensor 308 are used as a sensor group that detects a change in the attitude of the display 3. However, the sensors provided on the display 3 are not limited to the acceleration sensor 307 and the magnetic field sensor 308. For example, the sensors provided on the display 3 may include sensors capable of detecting the change in the attitude of the display 3, such as a gyro sensor or the like. In addition, at least one of the acceleration sensor 307 and the magnetic field sensor 308 may be used as the sensor for detecting the change in the attitude of the display 3.

The main memory 303, the NAND flash memory 310, and the SPI-ROM 311 are connected to the decoder processor 302 via buses. The WLAN 305 is connected to the decoder processor 302 via an USB. In addition, the WLAN 305 is connected to an antenna 306, and receives the image data transmitted from the PC 1 via the antenna 306.

The decoder processor 302 is an example of a main processing circuit of the wireless device 300. The decoder processor 302 may be formed by a dedicated processor for performing processes of functions more discrete than those of the CPU 101, and having a lower power consumption than the CPU 101. Accordingly, it is possible to reduce the weight of the portable display 30. For example, the decoder processor 302 subjects the image data transmitted from the wireless device 200 (that is, the PC 1) to a processing such as decompression, decoding, or the like. The decoder processor 302 outputs a signal (RF-MAX) indicating whether the wireless communication to the USB microcomputer 301 is possible.

The acceleration sensor 307 detects accelerations in three (3) mutually perpendicular axes of the display 3, and computes the inclination of the display 3. The magnetic field sensor 308 detects the orientation (or direction) of the magnetic field, and computes the direction in which the display 3 is rotated. Detection values of the acceleration sensor 307 and the magnetic field sensor 308 are sent to the USB microcomputer 301. The USB microcomputer 301 generates the attitude data of the display 3, based on the rotation direction and the inclination of the display 3, that is, based on the change in the attitude of the display 3 that is detected.

The USB sub 304 intermediates between the WLAN 305 and the decoder processor 302, and transmits desired data. The attitude data generated by the USB microcomputer 301 are output to the decoder processor 302 via the USB hub 304, and are transmitted from the decoder processor 302 to the encoder processor 202 of the PC 1, to notify the attitude data from the encoder processor 202 to the CPU 101.

Based on the notified attitude data, the CPU 101 performs the screen rotation process to rotate the image data displayed on the screen of the display 3. The rotated image data are supplied from the CPU 101 to the USB microcomputer 301 via the encoder processor 202 and the decoder processor 302 in this order, to be displayed on an LCD (Liquid Crystal Display) panel 313. Hence, the image on the screen may be rotated and displayed, according to the change in the attitude of the display 3. Accordingly, head and tail of the image on the screen can be displayed correctly by following the change in the attitude of the display 3.

The radio monitoring controller 309 monitors a state or level of radio waves of the wireless communication using the antenna 306, and notifies the monitored state or level of the radio waves to the USB microcomputer 301. The USB microcomputer 301 transfers the attitude data by controlling an amount of data of the attitude data according to the monitored state or level of the monitored radio waves. For example, in a case in which the USB microcomputer 301 judges that the state of the radio waves is poor based on the monitored state or level of the radio waves, the USB microcomputer 301 transfers the attitude data by controlling the amount of data of the attitude data to become smaller than that for a case in which the USB microcomputer 301 judges that the state of the radio waves is good. The process of reducing the amount of data of the attitude data to be transferred may be executed by the USB microcomputer 301. Alternatively, a filter function for reducing the amount of data of the attitude data may be provided in the acceleration sensor 307 and the magnetic field sensor 308, and the process of reducing the amount of data of the attitude data to be transferred may be executed in the acceleration sensor 307 and the magnetic field sensor 308.

The NAND flash memory 310 and the SPI-ROM 311 may store programs to be executed by the decoder processor 302.

The docking mechanism 312 may be a connector having a structure capable of connecting to the docking mechanism 212 provided on wireless device 200 illustrated in FIG. 1. The docking signal is output by the physical docking of the PC 1 and the display 3 using the docking mechanisms 212 and 312. In this embodiment, the docking mechanism 312 is provided in a longitudinal direction and a latitudinal direction of the display 3. The latitudinal direction refers to a short or widthwise direction that is perpendicular to the longitudinal direction. Hence, a user may stabilize the attitude of the display 3 by docking the PC 1 and the display 3 in a state in which the longitudinal direction of the screen extends horizontally or vertically.

The display 3 may include the LCD panel 313. The LCD panel 313 is an example of a liquid crystal display that displays, on the screen thereof, the image data transferred from the PC 1 via the decoder processor 302. The USB microcomputer 301 outputs to the LCD panel 313 a backlight control signal which will be described later. Based on the backlight control signal, the USB microcomputer 301 controls at least one of turning off a backlight of the screen, turning on the backlight of the screen, and a luminance of the backlight, when displaying the rotated image data on the screen.

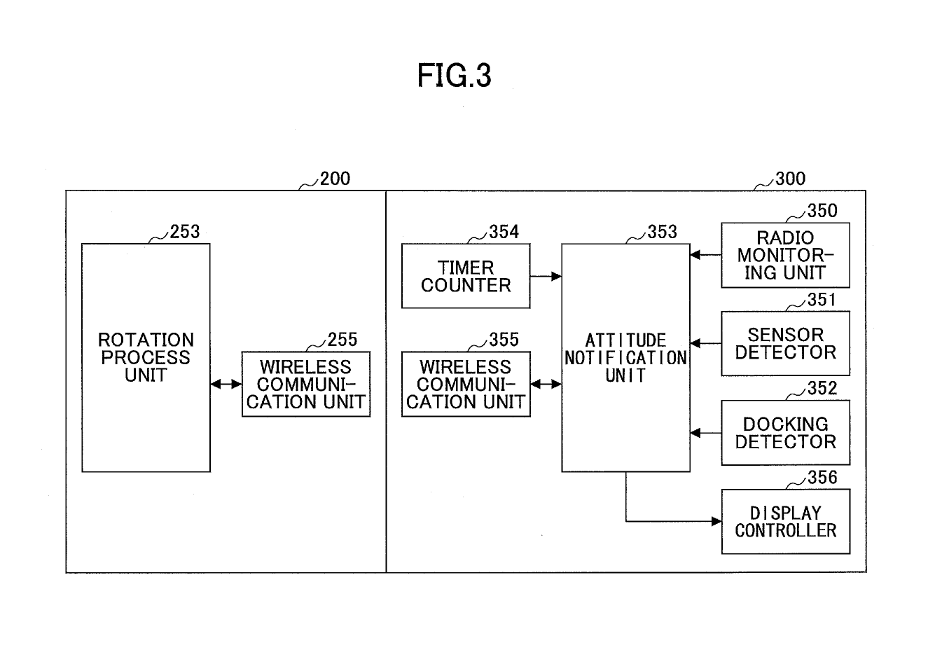

The hardware configuration of the PC 1 including the wireless device 200 in one embodiment, and the hardware configuration of the display 3 including the wireless device 300 in one embodiment, are as described above. Next, a description will be given of an example of a functional configuration of the wireless devices 200 and 300, by referring to FIG. 3. FIG. 3 is a block diagram illustrating the example of the functional configuration of the wireless devices 200 and 300 in one embodiment.

[Functional Configuration of Wireless Devices]

[Wireless Device 200]

The wireless device 200 of the PC 1 includes a rotation process unit 253 and a wireless communication unit 255. The rotation process unit 253 performs a desired rotation process on the image data on the screen of the display 3, based on the attitude data notified from the display 3.

The wireless communication unit 255 transmits the image data that have been subjected to the desired rotation process, that is, the rotated image data, to the display 3. The wireless communication unit 255 is an example of a first communication device that transmits the rotated image data to the display 3.

In this embodiment, the functions of the rotation process unit 253 are mainly performed by the CPU 101, and the functions of the wireless communication unit 255 are mainly performed by the WLAN 204.

[Wireless Device 300]

The wireless device 300 of the display 3 includes a radio monitoring unit 350, a sensor detector 351, a docking detector 352, an attitude notification unit 353, a timer counter 354, a wireless communication unit 355, and a display controller 356.

The radio monitoring unit 350 monitors the state or level of the radio waves output from the antenna 306, and notifies the monitored state or level of the radio waves to the attitude notification unit 353.

The sensor detector 351 detects the change in the attitude of the display 3. For example, the sensor detector 351 may detect any data specifying the attitude of the display 3, such as the orientation (or direction), the inclination, the rotation direction or the rotation angle, or the like of the display 3, for example.

The docking detector 352 detects a docking state between the docking mechanisms 212 and 312. More particularly, when the docking detector 352 detects the docking signal that is set to the low level, the attitude notification unit 353 judges that the PC 1 and the display 3 are physically docked.

In a state in which the display 3 is detached from the PC 1, the attitude notification unit 353 generates the attitude data of the display 3 based on the detected change in the attitude of the display 3, and notifies the attitude data to the PC 1. The attitude notification unit 353 may generate and notify, to the PC 1, the attitude data of the display 3 after a predetermined time elapses from a time when the attitude of the display 3 stabilizes and no longer changes. However, in the case in which the docking of the PC 1 and the display 3 is detected, the attitude notification unit 353 may generate the attitude data of the display based on the change in the attitude of the display 3, without waiting for the predetermined time to lapse. The timer counter 354 counts the predetermined time (for example, several seconds) from the time when the attitude of the display 3 no longer changes.

The attitude notification unit 353 may monitor the state of the radio waves received by the display 3, and generate and notify, to the PC 1, the attitude data by controlling the amount of data of the attitude data to become smaller than that for the case in which the state of the radio waves is good.

The wireless communication unit 355 receives the image data of the PC 1 from the wireless communication unit 255. The wireless communication unit 355 is an example of a second communication device that transmits the attitude data of the display 3 to the first communication device, using a band different from a band in which the image data are transmitted and received.

The wireless communication unit 355 transmits the attitude data (or USB data) to the wireless communication unit 255 using the band different from the band used to transmit and receive the image data. The wireless communication bands (or radio communication bands) between the wireless communication units 255 and 355 are divided into the band for transferring the image data and the band for transferring the USB data, so that the communication of the image data and the communication of the USB data can both be performed smoothly. The band used for the communication of the USB data is a band of 2 Mbps, for example. This band used for the communication of the USB data is a fixed wireless communication band that is usable with priority over the band used for the communication of the image data. On the other hand, the band used for the communication of the image data is a variable wireless communication band of 8 Mbps to 40 Mbps, for example.

In this embodiment, the attitude data are converted into the USB data, and are thereafter transmitted from the wireless communication unit 355 to the wireless communication unit 255. The attitude data do not necessarily have to be converted into the USB data when transferring the attitude data to the PC 1. However, the attitude data are preferably converted according to a general-purpose interface so as not to generate a data conversion process in the decoder processor 302 when transferring the attitude data to the PC 1.

The display controller 356 displays, on the LCD panel 313, the image data subjected to the rotation process and rotated by the rotation process unit 253 of the PC 1. When making the display on the LCD panel 313, the display controller 356 controls at least one of turning off the backlight of the screen, turning on the backlight of the screen, and the luminance of the backlight, when displaying the rotated image data on the screen of the LCD panel 313. Accordingly, even in a case in which noise is generated at a time when the image on the screen is switched, it is possible to control the screen so that the noise is uneasily recognized by the user who views the screen.

In this embodiment, the functions of the radio monitoring unit 350 are mainly performed by the radio monitoring controller 309. The functions of the sensor detector 351 are mainly performed by the acceleration sensor 307 and the magnetic field sensor 308. The functions of the docking detector 352 are mainly performed by the docking mechanism 312. The functions of the attitude notification unit 353 and the display controller 356 are mainly performed by the USB microcomputer 301. The functions of the wireless communication unit 355 are mainly performed by the WLAN 305.

[Signal Flow and Data Flow]

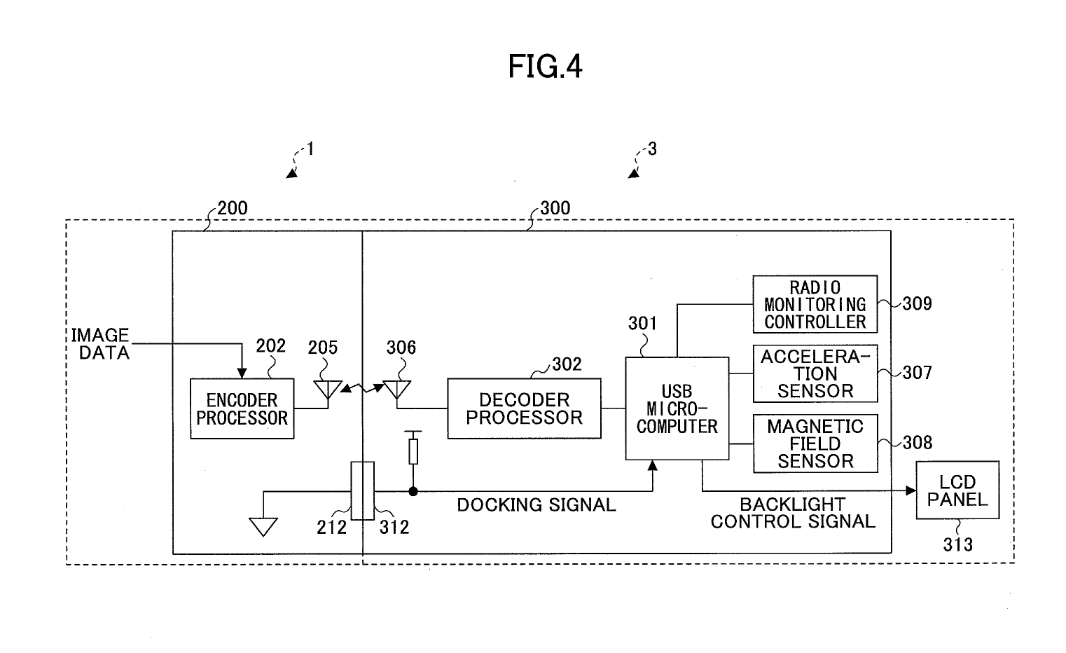

Next, a description will be given of signal and data flow between the wireless devices 200 and 300 in one embodiment. FIG. 4 is a block diagram illustrating an example of a docking state of the wireless devices 200 and 300 in one embodiment.

The USB microcomputer 301 inputs the docking signal that is set to the low level, while the docking mechanisms 212 and 312 are docked to each other. In addition, the USB microcomputer 301 outputs a backlight control signal for controlling the backlight of the LCD panel 313.

The USB microcomputer 301 generates the attitude data of the display, based on the detection values of the acceleration sensor 307 and the magnetic field sensor 308. The USB microcomputer 301 converts the attitude data of the display 3 into the USB data, and transmits the USB data to the decoder processor 302. The USB microcomputer 301 transfers the USB data to the encoder processor 202 via the decoder processor 302 and the encoder processor 202 in this order. The CPU 101 of the PC 1 performs the rotation process on the image data displayed on the screen of the display 3, based on the attitude data transferred from the display 3.

The image data are constantly transferred between the decoder processor 302 and the encoder processor 202, and the video is displayed on the LCD panel 313. In this state, if the decoder processor 302 were to perform a process different from the image data transfer process (for example, a process required to transfer the attitude data), the image data transfer process would be temporarily interrupted to cause instability and deteriorate a video quality of the display on the LCD panel 313. Accordingly, the decoder processor 302 in this embodiment is designed to minimize processes to be performed, other than the image data transfer process. In this case, the video quality of the display on the LCD panel 313 of the display 3 can be stabilized.

In other words, in this embodiment, the USB microcomputer 301 generates the attitude data according to the change in the state of the display 3, and converts the attitude data into the USB data that are output to the decoder processor 302. The decoder processor 302 transfers the USB data (or converted data) to the encoder processor 202.

As described above, the wireless communication bands between the decoder processor 302 and the encoder processor 202 are divided into the band for transferring the image data and the band for transferring the USB data, and these bands are preset. The band used for the communication of the USB data is usable with priority over the band used for the communication of the image data. For this reason, the attitude data can be transferred using the fixed wireless communication band that is prioritized over the wireless communication band used by the image data.

The image data can be transferred between the decoder processor 302 and the encoder processor 202 using the variable wireless communication band different from the fixed wireless communication band used by the USB data. Hence, the image data can be transferred smoothly between the decoder processor 302 and the encoder processor 202. As a result, it is possible to stabilize the video quality of the display on the LCD panel 313. Accordingly, it is possible to transmit the attitude data without affecting the video quality of the image data transferred between the encoder processor 202 and the decoder processor 302, and the rotation process on the image data displayed on the screen of the display 3, conforming to or matching the attitude of the display 3, can be executed in the PC 1.

[Screen Rotation Process]

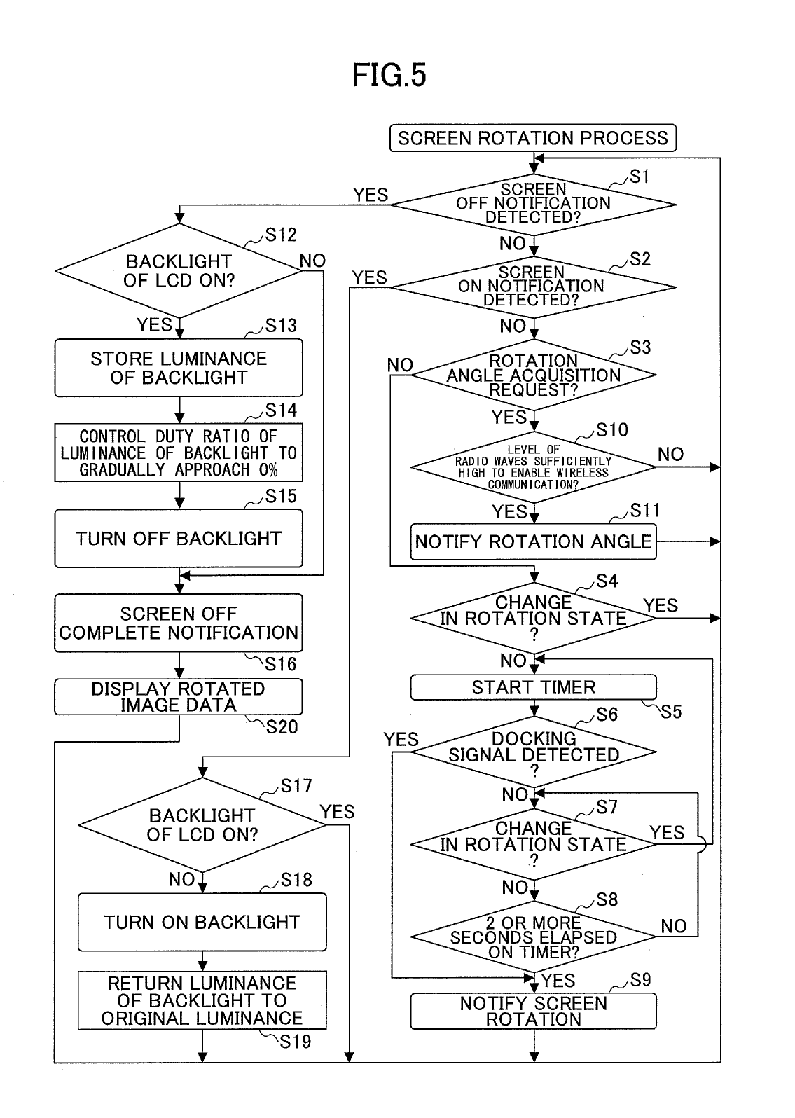

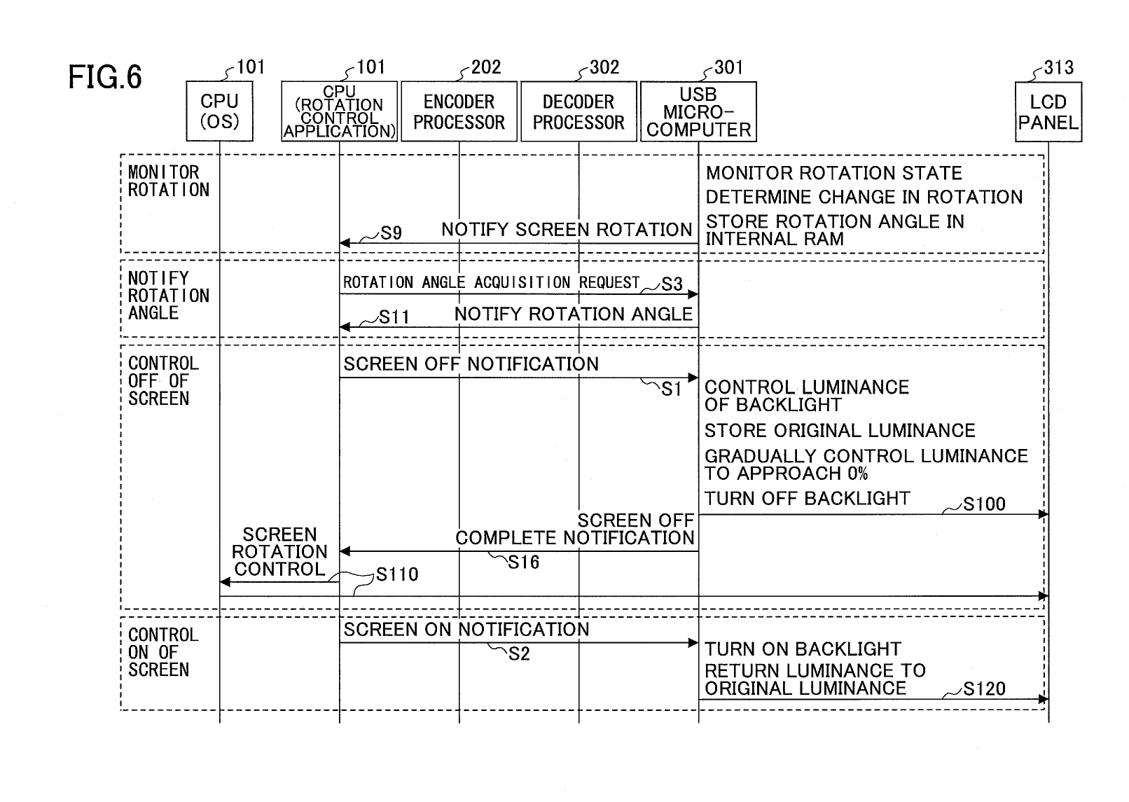

Next, a description will be given of an example of the screen rotation process in one embodiment, by referring to FIG. 5. FIG. 5 is a flow chart for explaining the example of the screen rotation process in one embodiment. FIG. 6 is a time chart for explaining the example of the screen rotation process in one embodiment.

The screen rotation process described hereunder is controlled by the USB microcomputer 301, and mainly by the attitude notification unit 353. Before describing the screen rotation process in this embodiment, a description will be given of a precondition of this embodiment. The precondition is that the USB microcomputer 301 analyzes the detection values of the acceleration sensor 307 and the magnetic field sensor 308, and generates the attitude data of the display 3. In addition, after the USB microcomputer 301 converts the attitude data into the USB data, the USB microcomputer 301 transfers the USB data to the CPU 101 via the decoder processor 302 and the encoder processor 202 in this order. Further, the CPU 101 performs the rotation process on image data displayed on the screen of the display 3 based on the attitude data. In other words, in this embodiment, it is a precondition that the PC 1 and the display 3 are separately provided (that is, are separate bodies), and that the rotation process on the image data displayed on the screen of the display 3 is executed in the PC 1.

When the screen rotation process illustrated in FIG. 5 is started, the USB microcomputer 301 judges whether a screen off notification is detected (step S1). At this point in time, the screen off notification is not sent to the USB microcomputer 301. Hence, the USB microcomputer 301 next judges whether a screen on notification is detected (step S2). At this point in time, the screen on notification is not sent to the USB microcomputer 301. Accordingly, the USB microcomputer 301 next judges whether a rotation angle acquisition is requested (step S3).

[Rotation Monitoring]

At this point in time, the rotation angle acquisition request is not sent to the USB microcomputer 301. Hence, the USB microcomputer 301 next judges whether there is a change in attitude of the display 3, such as rotation or the like of the display 3 (step S4). The USB microcomputer 301 repeats processes of steps S1 through S4 while the attitude of the display 3 changes. When the attitude of the display 3 no longer changes (NO in step S4), the USB microcomputer 301 starts the timer counter 354 (step S5).

Next, the USB microcomputer 301 judges whether the docking signal is detected (step S6). In a case in which the docking signal that is set to the low level is detected, it may be judged that the attitude of the display 3 will not change because the display 3 is physically docked to the PC 1. In this case, the USB microcomputer 301 stores the rotation angle of the display 3 in an internal storage region (for example, the SPI-ROM 311 illustrated in FIG. 2, or in other devices such as a RAM), and notifies a screen rotation of the display 3 to the PC 1 (step S9), and the process of the USB microcomputer 301 returns to step S1.

As a result, as illustrated in FIG. 6, the screen rotation notification is transferred from the USB microcomputer 301 to the CPU 101 via the decoder processor 302 and the encoder processor 202 in this order.

On the other hand, in a case in which the docking signal that is set to the low level is not detected in step S6, the USB microcomputer 301 again judges whether there is a change in the attitude of the display 3, such as rotation or the like of the display 3 (step S7). In a case in which it is judged that there is a change in the attitude of the display 3 (YES in step S7), the USB microcomputer 301 resets the timer counter 354 and restarts the timer counter 354 (step S5), to again perform the processes of step S6 and subsequent steps. In a case in which the attitude of the display 3 does not change and 2 or more seconds elapses on the timer counter 354 (YES in step S8), the USB microcomputer 301 notifies the screen rotation of the display 3 to the PC 1 (step S9), and the process of the USB microcomputer 301 returns to step S1. In this case, as illustrated in FIG. 6, the screen rotation notification is also transferred between the decoder processor 302 and the encoder processor 202, and transmitted to the CPU 101.

The CPU 101 starts a rotation control application (or program) in response to receiving the screen rotation notification. The rotation control application transmits the rotation angle acquisition request (step S3 in FIG. 6). The rotation angle acquisition request is transferred from the CPU 101 to the USB microcomputer 301 via the encoder processor 202 and the decoder processor 302 in this order.

[Rotation Angle Notification]

Returning to the description of FIG. 5, at this point in time, the process of the USB microcomputer 301 advances to steps S2 and S3 from step S1, and judges in step S3 that the rotation angle acquisition request is received. Hence, the process of the USB microcomputer 301 advances to step S10 to judge whether the level of the radio waves is sufficiently high to enable the wireless communication (or radio communication). The USB microcomputer 301 acquires, from the radio monitoring controller 309, the level of the radio waves, and uses the acquired level for the judgment in step S10.

In a case in which the level of the radio waves is insufficient to enable the wireless communication (NO in step S10), the process of the USB microcomputer 301 returns to step S1 to again repeat the processes of steps S1 through S3 and S10. For example, the process of the USB microcomputer 301 may return to step S1 in a case in which the wireless communication is not possible as a result of making the judgment of step S10 a plurality of times.

In a case in which the level of the radio waves is sufficient to enable the wireless communication (YES in step S10), the process of the USB microcomputer 301 advances to step S11 to notify the stored rotation angle of the display 3 to the PC 1, and the process of the USB microcomputer 301 returns to step S1. Accordingly, as illustrated in step S11 in FIG. 6, the rotation angle of the display is notified from the USB microcomputer 301 to the CPU 101. The rotation angle that is notified to the CPU 101 is an example of the attitude data of the display 3.

The display 3 constantly receives the image data from the PC 1. In other words, the image data are constantly transferred between the decoder processor 302 and the encoder processor 202. For this reason, rotation angle data notified in step S11 are preferably varied according to the level of the radio waves, so as not to affect the video quality of the image data displayed on the display 3.

For example, in a case in which the level of the radio waves is sufficient to enable the wireless communication and is greater than or equal to a preset threshold value, all of the sensor values detected by the acceleration sensor 307 and the magnetic field sensor 308 may be included in the rotation angle data. On the other hand, in a case in which the level of the radio waves is insufficient to enable the wireless communication and is less than the preset threshold value, only the rotation angles 0°, 90°, 180°, and 270°, amongst the sensor values, may be included in the rotation angle data. By varying the amount of information (or amount of data) of the attitude data that are transferred according to the level of the radio waves, it is possible to stabilize the video quality of the image data displayed on the display 3. In addition, it is possible to improve a response of the display 3.

When the rotation angle is notified to the PC 1, the rotation control application transmits the screen off notification in step S1 illustrated in FIG. 6. The screen off notification is transferred to the USB microcomputer 301.

[Screen Off Control]

Returning to the description of FIG. 5, at this point in time, the USB controller 301 judges in step S1 that the screen off notification is detected (YES in step S1), and the process of the USB controller 301 advances to step S12 to judge whether the backlight of the LCD panel 313 is on. In a case in which the backlight of the LCD panel 313 is not on (that is, off) (NO in step S12), the USB microcomputer 301 transmits a screen off complete notification (step S16). In addition, the USB microcomputer 301 displays on the display 3 the rotated image data subjected to the rotation process in the PC 1 (step S20), and the process of the USB microcomputer 301 returns to step S1.

On the other hand, in a case in which the backlight of the LCD panel 313 is on (YES in step S12), the process of the USB microcomputer 301 advances to step S13 to store a luminance of the backlight at this point in time. Next, the USB microcomputer 301 controls a duty ratio of the luminance of the backlight to gradually approach 0% (step S14). Next, the USB microcomputer 301 turns off the backlight of the LCD panel 313 (step S15), and transmits the screen off complete notification (step S16). In addition, the USB microcomputer 301 displays on the display 3 the rotated image data subjected to the rotation process in the PC 1 (step S20), and the process of the USB microcomputer 301 returns to step S1.

Accordingly, as illustrated in step S100 in FIG. 6, the USB microcomputer 301 controls the duty ratio of the luminance of the backlight of the LCD panel 313 of the display 3 to gradually approach 0%, and thereafter controls the backlight to turn off.

When the rotation control application receives the screen erase complete notification, the rotation control application executes the screen rotation process of step S110 illustrated in FIG. 6. By sending the attitude data of the display 3 to the OS stored in the HDD 103, the rotation control application can cause the OS to execute the rotation process on the image data on the screen. The rotated image data, subjected to the rotation process in the PC 1, are displayed on the screen of the display 3 (Step S20 in FIG. 5).

In addition, as illustrated in FIG. 6, the rotation control application transmits the screen on notification in step S2.

[Screen On Control]

Returning to the description of FIG. 5, at this point in time, the process the USB microcomputer 301 advances from step S1 to step S2, to judge whether the screen on notification is detected. In the case in which the screen on notification is detected (YES in step S2), the process of the USB microcomputer 301 advances to step S17 to judge whether the backlight of the LCD panel 313 is on. In a case in which the backlight of the LCD panel 313 is on (YES in step S17), the process of the USB microcomputer 301 immediately returns to step S1.

On the other hand, in a case in which the backlight of the LCD panel 313 is not on (that is off) (NO in step S17), the USB microcomputer 301 turns on the backlight of the LCD panel 313 (step S18). Next, the USB microcomputer 301 returns the luminance of the LCD panel 313 back to the original luminance that is stored in step S13 (step S19), and the process of the USB microcomputer 301 returns to step S1. Accordingly, as illustrated in step S120 in FIG. 6, the USB microcomputer 301 controls the backlight of the LCD panel 313 of the display 3 to turn on, and controls the luminance of the backlight back to the original luminance that is stored.

[Advantageous Effects or Features]

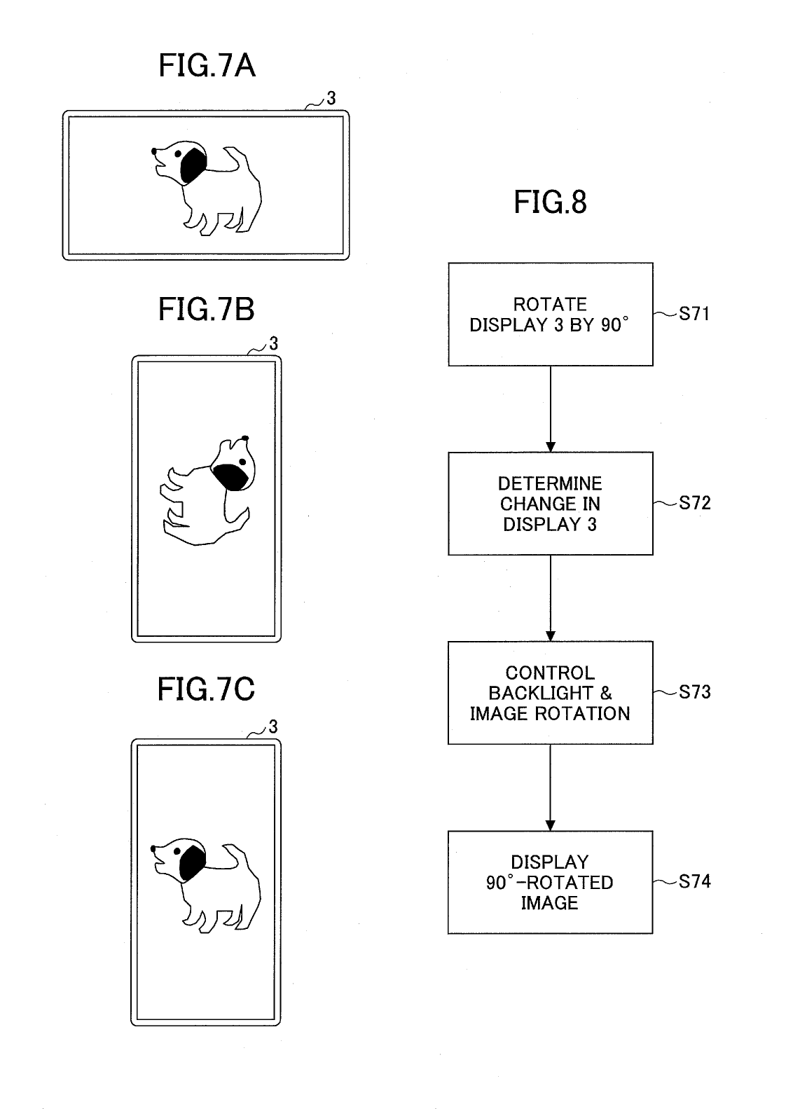

Finally, a description will be given of the effects of the screen rotation process in this embodiment, by referring to FIGS. 7A through 7C and 8. FIGS. 7A, 7B, and 7C are diagrams for explaining effects of the screen rotation process in one embodiment, and FIG. 8 is a flow chart for explaining the screen rotation process illustrated in FIGS. 7A through 7C.

In FIG. 7A, the display 3 is arranged in a state in which the longitudinal direction of the screen extends horizontally. In step S71 illustrated in FIG. 8, the user rotates the display 3 that is arranged in this state by 90° in a clockwise direction, for example. The display 3 is rotated to a state illustrated in FIG. 7B in which the longitudinal direction of the screen extends vertically. When the USB microcomputer 301 judges that the predetermined time (for example, 2 seconds) elapsed from the time when the attitude of the display 3 no longer changes from the state illustrated in FIG. 7B, in step S72 illustrated in FIG. 8, the USB microcomputer 301 judges that the change in the attitude of the display 3 is determined (or fixed). In step S73 illustrated in FIG. 8, the USB microcomputer 301 generates the attitude data of the display 3 based on the change in the attitude of the display 3 that is determined in step S72. For example, the USB microcomputer 301 may generate the rotation angle data (90° in this example), as an example of the attitude data of the display 3. The USB microcomputer 301 notifies rotation angle data, that are generated as an example of the attitude data, from the display 3 to the PC 1.

In response to receiving the rotation angle data, notified from the display 3 as an example of the attitude data, the PC 1 executes a back light control process, and an image data rotation process based on the rotation angle data (90° in this example). Results of the backlight control process and the image data rotation process are notified from the PC 1 to the display 3.

In response to receiving the results the backlight control process and the image data rotation process, notified from the PC 1, the USB microcomputer 301, in step S74 illustrated in FIG. 8, displays the 90°-rotated image data, rotated in the clockwise direction from the state illustrated in FIG. 7B, on the LCD panel 313 of the display 3 as illustrated in FIG. 7C.

Although FIGS. 7A through 7C illustrate the manner in which the image data are rotated and displayed on the display 3, the screen illustrated in FIG. 7B occurs only for an instant, and a transition of the screen from the state illustrated in FIG. 7B to the state illustrated in FIG. 7C occurs instantaneously, that is, within a short time. The back light control process is also executed during this short time. For this reason, to the user, the screen appears as if the transition takes place from the state illustrated in FIG. 7A to the state illustrated in FIG. 7C.

As described above, according to the screen rotation process in this embodiment, in the information processing apparatus in which the display 3 and the PC 1 are separately provided, it is possible to instantaneously display, on the display 3, the rotated image data subjected to the rotation process that is executed in the PC 1 according to the rotation (or attitude) of the display 3. In addition, it is possible to control the rotation of the image data on the screen according to the rotation of the display 3, without stressing the wireless bands used for the image data transfer process between the PC 1 and the display 3.

Moreover, according to the screen rotation process in this embodiment, the backlight of the LCD panel 313 is controlled to turn off in response to an instruction from the CPU 101 (or rotation control application) before performing the screen rotation control. After the backlight is controlled to turn off, the CPU 101 (or OS) transfers the image data rotated by the rotation process. After the rotated image data are displayed on the LCD panel 313, the backlight is controlled to turn on after a predetermined elapses. Hence, while the image data on the screen is rotated and displayed according to the operation of rotating the display 3, instability or disorder on the screen is uneasily visually recognized by the user by controlling the backlight to turn on or off instantaneously.

The screen rotation process described above is executed in the information processing apparatus in one embodiment having the PC 1 and the display 3 that is detachably provided on the PC 1. According to the screen rotation process in this embodiment, it is possible to rotate the image data on the screen of the display 3 having no image rotation function, according to the attitude of the display 3.

The information processing apparatus in this disclosure is not limited to the example of the information processing apparatus described above, and various variations and modifications may be made without departing from the scope of the present invention.

For example, the example described above performs the screen rotation process to rotate the image data on the screen as an example of the process performed on the image data by the information processing apparatus. However, the process performed on the image data is not limited to the screen rotation process, and may include processes such as enlarging the image data displayed within a window on the screen, reducing the image data displayed within the window on the screen, or the like.

According to the embodiments and modifications thereof, it is possible to provide an information processing apparatus including a body and a display detachably provided on the body, that can rotate an image on the display having no image rotating function, according to an attitude of the display.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a body; and
a display detachably provided on the body,
wherein the display comprises a first processor configured to perform a process including
generating attitude data of the display based on a change in attitude of the display detected in a state in which the display is detached from the body, to notify the attitude data to the body, and
wherein the body comprises a second processor configured to perform a process including
performing a rotation process on image data displayed on the display and output rotated image data, based on the attitude data of the display, and
first transmitting the rotated image data to the display.

2. The information processing apparatus as claimed in claim 1, wherein the first processor of the display performs the process further including
second transmitting the attitude data of the display to the body, using a band different from a band in which the image data are transmitted and received between the body and the display.

3. The information processing apparatus as claimed in claim 1, wherein the generating generates the attitude data of the display based on the change in the attitude of the display, after a predetermined time elapses from a time when the attitude of the display no longer changes.

4. The information processing apparatus as claimed in claim 3, wherein the first processor of the display performs the process further including
detecting docking of the display to the body,
wherein, in a case in which the detecting detects the docking, the generating generates the attitude data of the display based on the change in the attitude of the display, without waiting for the predetermined time to lapse from the time when the attitude of the display no longer changes, to notify the attitude data to the body.

5. The information processing apparatus as claimed in claim 2, wherein the generating notifies the attitude data to the body by controlling an amount of data of the attitude data according to a state of radio waves in wireless communication between the body and the display.

6. The information processing apparatus as claimed in claim 1, wherein the first processor of the display performs the process further including
controlling at least one of turning off a backlight of a screen of the display, turning on the backlight of the screen, and a luminance of the backlight of the screen, when displaying the rotated image data on the screen.

7. The information processing apparatus as claimed in claim 1, wherein the display further comprises:
a sensor group configured to detect the change in the attitude of the display.

8. The information processing apparatus as claimed in claim 7,
wherein the sensor group includes an acceleration sensor that detects accelerations in three mutually perpendicular axes of the display, and a magnetic field sensor that detects an orientation of a magnetic field, and
wherein the first processor of the display performs the process further including
computing an inclination of the display based on the accelerations detected by the acceleration sensor, and
computes a direction in which the display is rotated based on the orientation detected by the magnetic field sensor.

9. The information processing apparatus as claimed in claim 1,
wherein, in a state in which the display is detached from the body, the first transmitting transmits the image data or the rotated image data by wireless communication to the display using a first band, and
wherein the first processor of the display performs the process further including
in the state in which the display is detached from the body, second transmitting the attitude data of the display to the body by wireless communication using a second band different from the first band.

10. A display detachable with respect to a body of an information processing apparatus, comprising:
a sensor group configured to detect attitude of the display;
a screen; and
a processor configured to perform a process including
generating attitude data of the display based on a change in the attitude of the display detected by the sensor group in a state in which the display is detached from the body,
notifying the attitude data to the body, and
receiving rotated image data of the image data from the body, rotated in the body based on the attitude data, and
displaying the rotated image data, received by the receiving, on the screen,
wherein the notifying and the receiving perform wireless communication in a state in which the display is detached from the body.

11. The display as claimed in claim 10, wherein the notifying transmits the attitude data of the display to the body using a band different from a band in which the image data or the rotated image data are received from the body by the receiving.

12. The display as claimed in claim 10, wherein the generating generates the attitude data of the display based on the change in the attitude of the display, after a predetermined time elapses from a time when the attitude of the display detected by the sensor group no longer changes.

13. The display as claimed in claim 12, wherein the processor performs the process further including
detecting docking of the display to the body, and
wherein the generating generates the attitude data of the display based on the change in the attitude of the display, without waiting for the predetermined time to lapse from the time when the attitude of the display detected by the sensor group no longer changes, in a case in which the detecting detects the docking.

14. The display as claimed in claim 11,
wherein the processor performs the process further including
monitoring a state of radio waves in wireless communication between the display and the body, and
wherein the notifying notifies the attitude data to the body by controlling an amount of data of the attitude data according to the state of radio waves monitored by the monitoring.

15. The display as claimed in claim 10, further comprising:
a backlight of the screen,
wherein the processor performs the process further including
controlling at least one of turning off the backlight, turning on the backlight, and a luminance of the backlight, when the displaying displays the rotated image data on the screen.
